(19) United States
(12) Patent Application Publication
(10) Pub. No.: US 2009/0033832 A1
(43) Pub. Date: Feb. 5, 2009

(54) BACKLIGHT MODULE AND APPLICATION THEREOF

(75) Inventor: Wei-Ming Pai, Tainan County (TW)

Correspondence Address: PAI PATENT & TRADEMARK LAW FIRM, 1001 FOURTH AVENUE, SUITE 3200, SEATTLE, WA, 98154, US

(73) Assignee: CHI MEI LIGHTING TECHNOLOGY CORP, TAINAN COUNTY (TW)

(21) Appl. No.: 11/852,329

(22) Filed: Sep. 10, 2007

(30) Foreign Application Priority Data
Jul. 31, 2007 (TW) 96128083

(51) Int. Cl. F21V 8/00; F21V 13/04; G02F 1/13357

(52) U.S. Cl. 349/65; 362/606; 362/608; 362/611; 362/624; 362/625; 362/626; 362/628

(57) ABSTRACT

A backlight module and an application thereof are disclosed. The backlight module comprises at least one light source and a light guide plate. The light guide plate is disposed at one side of the light source, wherein the light guide plate has a reducing region formed at one side of the light guide plate and close to the light source. The thickness of the light guide plate in the reducing region is decreased with the increasing distance away from the light source. The backlight module is applicable to a liquid crystal display (LCD) apparatus.

### RELATED APPLICATIONS

This application claims priority to Taiwan Application Serial Number 96128083, filed Jul. 31, 2007, which is herein incorporated by reference.

### FIELD OF THE INVENTION

This invention relates to a backlight module and an application thereof, and more particularly, to a backlight module which can reduce the thickness thereof and an application of a liquid crystal display apparatus.

### BACKGROUND OF THE INVENTION

Liquid crystal displays (LCD) have been widely applied in electrical products due to the rapid progress of optical and semiconductor technologies. With their advantages of high image quality, compact size, light weight, low driving voltage, low power consumption and various applications, LCD have been introduced into portable computers, mobile phones, personal digital assistants and color televisions and are becoming the mainstream display apparatus.

Currently, LCD mostly comprises a liquid crystal panel and a backlight module disposed behind the panel. Therefore, the backlight module is one of the key components of the LCD. According to the position of the backlight source, the backlight module can be an edge-lighting type or a bottom-lighting type to provide LCD with backlight.

Conventional edge-lighting backlight module uses a light guide plate to guide light through an optical filter for optical improvement, thereby forming a uniform planar light. Currently, since LCD is thinner and lighter, the backlight module has to reduce thickness and weight, correspondingly. However, when the edge-lighting backlight (such as using light-emitting-diode as the backlight source) decreases the size or the package size for reducing thickness and weight, the light coupling efficiency between the backlight source and the light guide plate also decreases, and the heat-radiating efficiency thereof is poor. Further, the manufacturing difficulty and cost are also raised.

### SUMMARY OF THE INVENTION

Therefore, an aspect of the present invention is to provide a backlight module and an application thereof to reduce the thickness thereof.

Another aspect of the present invention is to provide a backlight module and an application thereof to reduce the thickness, but not to decrease the size of the chamber and the light source, thereby enhancing the light coupling efficiency and the heat radiation efficiency.

According to an embodiment of the present invention, the backlight module comprises at least one light source and a light guide plate. The light guide plate is disposed at one side of the light source, wherein the light guide plate comprises a light emitting surface, a light reflection surface, at least one reducing region and a light emitting region. The light emitting surface is formed on the front side of the light guide plate. The light reflection surface is formed opposite to the light emitting surface. The reducing region is formed at one side of the light guide plate and close to the light source, wherein the thickness of the light guide plate in the reducing region is decreased with the increasing distance away from the light source. The light emitting region is formed at one side of the reducing region and opposite to the light source to emit light.

According to another embodiment of the present invention, the backlight module is applicable to a liquid crystal display (LCD) apparatus.

Therefore, with the use of the backlight module and the application thereof disclosed in the embodiments of the present invention, the thickness of the backlight module and the application thereof can be reduced, and the light coupling efficiency and the heat radiation efficiency can be enhanced.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a cross-section view showing a liquid crystal display panel and a backlight module according to a first embodiment of the present invention;

FIG. 2 is a partial cross-section view showing a light guide plate according to a second embodiment of the present invention;

FIG. 3 is a partial cross-section view showing a light guide plate according to a third embodiment of the present invention; and

FIG. 4 is a three dimensional view showing a light guide plate of a backlight module according to a fourth embodiment of the present invention.

### DETAILED DESCRIPTION OF THE PREFERRED EMBODIMENT

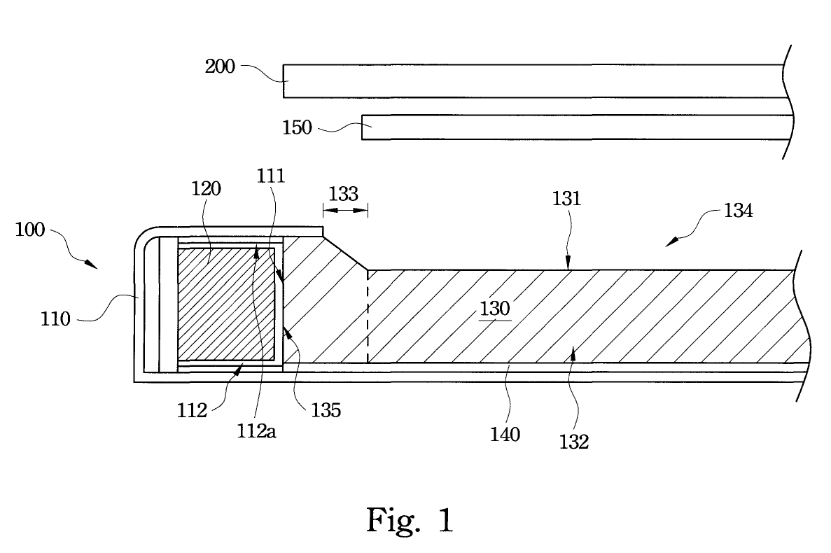

In order to make the illustration of the present invention more explicit and complete, the following description is stated with reference to FIG. 1 through FIG. 4.

Refer to FIG. 1. FIG. 1 is a cross-section view showing a liquid crystal display panel and a backlight module according to a first embodiment of the present invention. The backlight module 100 of the present embodiment is disposed below a liquid crystal display panel 200, thereby forming a liquid crystal display (LCD) apparatus. The backlight module 100 comprises a casing 110, at least one light source 120, a light guide plate 130, a reflection plate 140 and at least one optical film 150. The light source 120, the light guide plate 130 and the reflection plate 140 are disposed in the casing 110. The light source 120 is disposed at one side of the casing 110 to emit light into the light guide plate 130, and the light guide plate 130 guides light to output. The reflection plate 140 is disposed below the light guide plate 130 to reflect light. The optical film 150 is disposed above the light guide plate 130 for optical improvement.

Refer to FIG. 1 again. The casing 110 of the present embodiment includes a light emitting opening 111 and a chamber 112. The light emitting opening 111 allows light to output. In this embodiment, the casing 110 forms a lampshade with an airtight structure, thereby preventing light from leaking out, except from the light emitting opening 111, wherein the casing 110 may be made of opaque material, such as plastic material, metal or any composition thereof. The chamber 112 is formed at one side of the light guide plate 130 to receive the light source 120. The chamber 112 includes a light reflective material, such as Au, Ag, Al or any composition thereof, formed on the inner sidewall thereof to reflect the light that does not emit straight into the light guide plate 130. The light source 120 of the present embodiment may be cold cathode fluorescent lamp (CCFL), hot cathode fluorescent lamp (HCFL) and light emitting diode (LED).

Refer to FIG. 1 again. The light guide plate 130 of the present embodiment is disposed at one side of the light source 120 to guide light. The light guide plate 130 may be made by the method of injecting molding, thereby forming a flat plate structure, and the material of the light guide plate 130 is polypropylene for example. The light guide plate 130 comprises a light emitting surface 131, a light reflection surface 132, at least one reducing region 133, a light emitting region 134 and a light incidence surface 135. The light emitting surface 131 is formed on the front side of the light guide plate 130 to output light. The light reflection surface 132 is formed at the bottom of the light guide plate 130 and opposite to the light emitting surface 131. The reducing region 133 is formed at one side of the light guide plate 130 and close to the light source 120, wherein the thickness of the light guide plate 130 in the reducing region 133 is decreased with the increasing distance away from the light source 120. In this embodiment, the reducing region 133 has an inclined plane on the light emitting surface 131, and thus the thickness of the light guide plate 130 in the reducing region 133 is decreased with the increasing distance away from the light source 120. The light emitting region 134 is formed at one side of the reducing region 133 and opposite to the light source 120 to output light. The light incidence surface 135 is formed at another sight of the reducing region 133 and adjacent to the light emitting opening 111 of the casing 110 to allow the light emitted form the light source 120 into the reducing region 133. When light source 120 emits light, the light passes the reducing region 133 and is guided into the light emitting region 134 to output. The thickness of the light guide plate 130 in the light emitting region 134 is determined according to the thickness of the side of the reducing region 133 (away from the light source 120), i.e. the thickness of the light guide plate 130 in the light emitting region 134 is substantially less than the thickness in the reducing region 133, and i.e. the thickness in the light emitting region 134 is substantially less than the height of the light incidence surface 135 (or the height of the light emitting opening 111 of the casing 110). Therefore, the thickness of the light guide plate 130 is reduced (in the light emitting region 134) through the use of the reducing region 133.

For example, when the height of the light incidence surface 135 may be 2 mm, since the thickness of the light guide plate 130 in the light emitting region 134 is determined according to the thickness of the side of the reducing region 133 (away from the light source 120), the thickness thereof in the light emitting region 134 and the height of the light incidence surface 135 may be substantially larger than 0.1 mm, i.e. the thickness in the light emitting region 134 can be substantially less than 1.9 mm.

It is worth mentioning that the light incidence surface 135 may include a plurality of V-cut structures, a plurality of S-shaped structures or a roughed surface structure to enhance the light incidence efficiency and light coupling efficiency.

Refer to FIG. 1 again. The light guide plate 130 may further comprise a plurality of light guiding structures (not shown) formed in the light reflection surface 132 to guide the light emitted from the light source 120 to the light emitting surface 131. The light guiding structures of the light guide plate 130 may be a plurality of V-cut structures formed by a method such as injection molding or micro-finishing process, a stain surface formed by a method such as sanding process or a plurality of scattering patterns formed by a method such as printing, thereby guiding the light through the reducing region 133 to the light emitting surface 131.

It is worth mentioning that the light emitting surface 131 of the light guide plate 130 may include a stain surface or a plurality of scattering patterns to uniform light, i.e. the situation of mura is prevented.

Refer to FIG. 1 again. The reflection plate 140 of the present embodiment corresponds to the shape of the light reflection surface 132, thereby disposed below the light guide plate 130 closely for reflecting light. It is worth mentioning that the light reflection surface 132 may include a high reflectivity material formed thereon to reflect light, thereby replacing the reflection plate 140.

Refer to FIG. 1 again. The optical film 150 of the present embodiment may be diffuser, prism sheet, turning prism sheet, brightness enhancement film, dual brightness enhancement film, diffused reflective polarizer film or any composition thereof and is disposed above the light guide plate 130 for optical improvement.

When the backlight module 100 of the present embodiment provides backlight, the light emitted from the light source 120 passes through the reducing region 133 of the light guide plate 130 and is guided into the light emitting region 134, and then is output therefrom. Since the thickness of the light guide plate 130 in the reducing region 133 is decreased with the increasing distance away from the light source 120, and the thickness thereof in the light emitting region 134 is determined according to the thickness of the side of the reducing region 133, the thickness in the light emitting region 134 is reduced, thereby thinning the light guide plate 130, and further the thickness of the backlight module 100 can be reduced. Furthermore, the size of the chamber 112 and the light source 120 do not need to change. Therefore, the light coupling efficiency and the heat radiation efficiency can be enhanced.

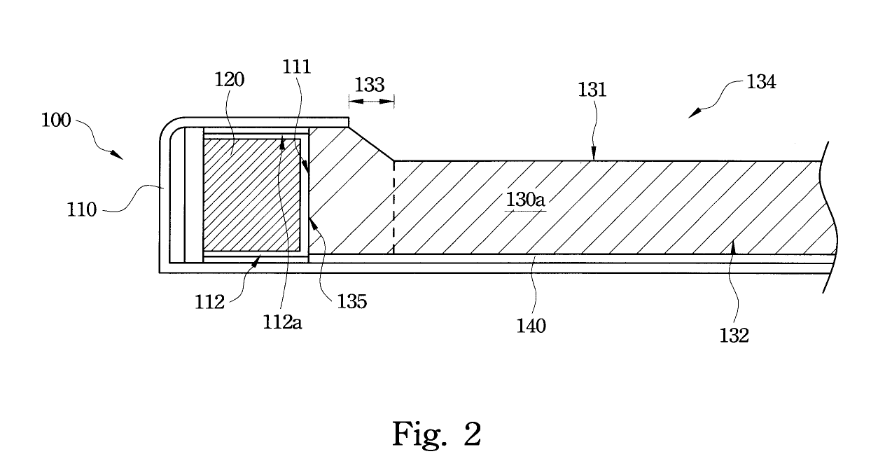

Refer to FIG. 2. FIG. 2 is a partial cross-section view showing a light guide plate according to a second embodiment of the present invention. Some reference numerals shown in the first embodiment are used in the second embodiment of the present invention. The construction of the light emitting diode shown in the second embodiment is similar to that in the first embodiment with respect to configuration and function, and thus is not stated in detail herein.

Referring again to FIG. 2, in comparison with the first embodiment, the light guide plate 130a is a wedge-shaped plate structure, wherein the thickness thereof close to the light source 120 is thicker than the thickness thereof away from the light source 120. At this time, the light guide plate 130a of the second embodiment may not have the light guiding structures, but uses the inclined plane (the light reflection surface 132a) of the light guide plate 130a to reflect the light to be output from the light emitting surface 131. Therefore, the thickness of the light guide plate 130 can be reduced through the use of the reducing region 133, and further the thickness of the backlight module 100 can be reduced.

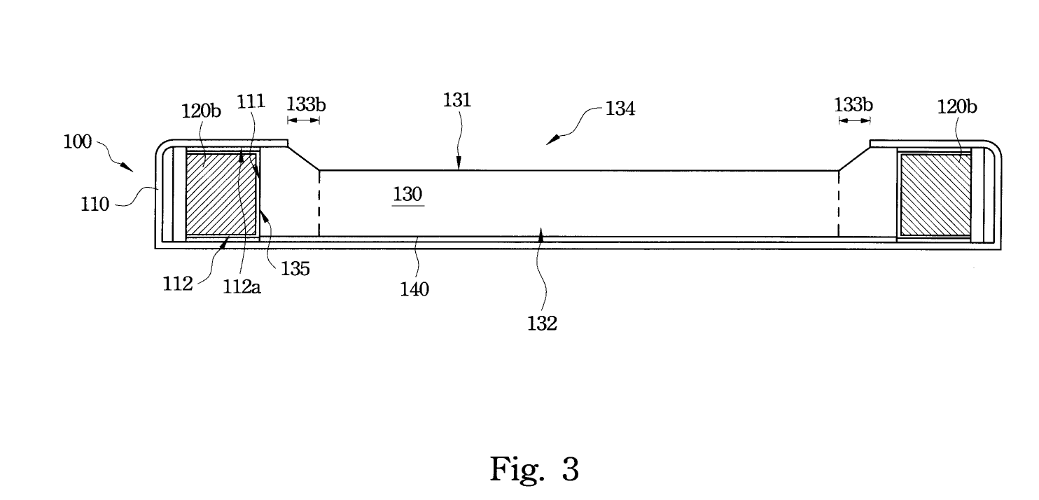

Refer to FIG. 3. FIG. 3 is a partial cross-section view showing a light guide plate according to a third embodiment of the present invention. Some reference numerals shown in the first embodiment are used in the third embodiment of the present invention. The construction of the light emitting diode shown in the third embodiment is similar to that in the first embodiment with respect to configuration and function, and thus is not stated in detail herein.

Referring again to FIG. 3, in comparison with the first embodiment, the backlight module 100 of the third embodiment comprises two light sources 120b and two reducing regions 133b disposed at both sides of the light guide plate 130 respectively. At this time, the reducing regions 133b can guide light into the light emitting region 134 from both sides of the light guide plate 130 respectively, thereby increasing the backlight provided by the backlight module 100, preferably for a large-scale display. Therefore, the thickness of the light guide plate 130 can be reduced through the use of the reducing region 133b, and further the thickness of the backlight module 100 can be reduced.

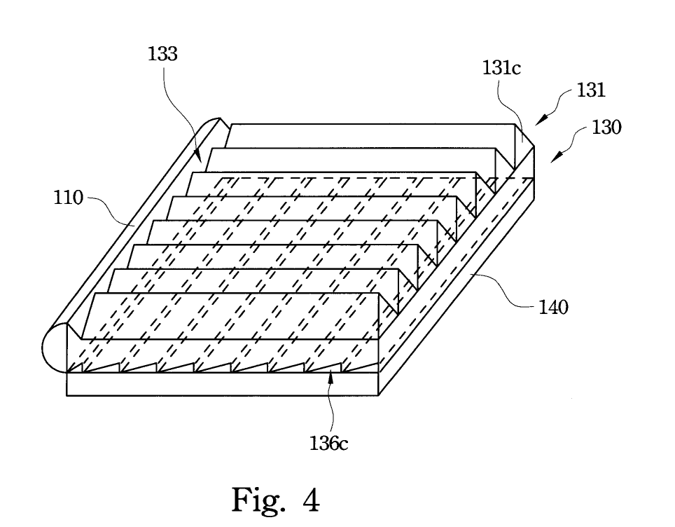

Refer to FIG. 4. FIG. 4 is a three dimensional view showing a light guide plate of a backlight module according to a fourth embodiment of the present invention. Some reference numerals shown in the first embodiment are used in the fourth embodiment of the present invention. The construction of the light emitting diode shown in the fourth embodiment is similar to that in the first embodiment with respect to configuration and function, and thus is not stated in detail herein.

Referring again to FIG. 4, in comparison with the first embodiment, the light emitting surface 131 of the light guide plate 130 includes a plurality of protruding structures 131c to modify the direction of light, thereby condensing light and enhancing the brightness thereof, wherein the protruding structures 131c may be a plurality of prism-shaped structures with the vertex angle such as between 90 and 135 degrees or a plurality of semicircle-shaped structures. Furthermore, when the protruding structures 131c are in the form of a plurality of long prism-shaped structures, and the light guiding structures 136c of the light guide plate 130 are a plurality of V-cut structures, the direction of the long prism-shaped structures (the protruding structures 131c) are preferably perpendicular to the direction of the light guiding structures 136c, thereby further enhancing the light condensing efficiency.

Therefore, the thickness of the backlight module and the application thereof can be reduced through the use of the reducing region. Furthermore, since the size of the chamber and the light source do not need to decrease, the light coupling efficiency and the heat radiation efficiency can be enhanced.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A backlight module, comprising:
at least one light source; and
a light guide plate disposed at one side of the light source, wherein the light guide plate comprises:
a light emitting surface formed on the front side of the light guide plate;
a light reflection surface formed opposite to the light emitting surface;
at least one reducing region formed at one side of the light guide plate and close to the light source, wherein the thickness of the light guide plate in the reducing region is decreased with the increasing distance away from the light source; and
a light emitting region formed at one side of the reducing region and opposite to the light source to emit light.

2. The backlight module as claimed in claim 1, wherein the light guide plate is a flat plate structure.

3. The backlight module as claimed in claim 1, wherein the light guide plate is a wedge-shaped plate structure.

4. The backlight module as claimed in claim 1, wherein the backlight module comprises two light sources and two reducing regions, and the light sources are disposed at two sides of the light guide plate respectively, and each of the reducing regions is formed between each of the light sources and the light guide plate.

5. The backlight module as claimed in claim 1, wherein the light guide plate further comprises:
a light incidence surface formed at another sight of the reducing region to allow the light emitted from the light source into the reducing region.

6. The backlight module as claimed in claim 5, wherein the light incidence surface includes a plurality of V-cut structures, a plurality of S-shaped structures or a roughed surface structure.

7. The backlight module as claimed in claim 5, wherein the difference between the thickness of the light guide plate in the light emitting region and the height of the light incidence surface is substantially larger than 0.1 mm.

8. The backlight module as claimed in claim 1, further comprises:
at least one optical film disposed on the light guide plate.

9. The backlight module as claimed in claim 8, wherein the optical film is selected from a group consisting of diffuser, prism sheet, turning prism sheet, brightness enhancement film, dual brightness enhancement film, diffused reflective polarizer film and any composition thereof.

10. The backlight module as claimed in claim 1, wherein the light source is selected from a group consisting of cold cathode fluorescent lamp (CCFL), hot cathode fluorescent lamp (HCFL) and light emitting diode (LED).

11. The backlight module as claimed in claim 1, wherein the light guide plate further comprises:
a plurality of light guiding structures formed on the light reflection surface.

12. The backlight module as claimed in claim 11, wherein the light guiding structures are a plurality of V-cut structures.

13. The backlight module as claimed in claim 11, wherein the light guiding structures includes a stain surface.

14. The backlight module as claimed in claim 11, wherein the light guiding structures are a plurality of scattering patterns.

15. The backlight module as claimed in claim 14, wherein the scattering patterns are formed by the method of printing.

16. The backlight module as claimed in claim 1, wherein the light reflection surface includes a stain surface or a plurality of scattering patterns.

17. The backlight module as claimed in claim 1, wherein the light reflection surface includes a high reflectivity material formed thereon to reflect light.

18. The backlight module as claimed in claim 1, wherein the light emitting surface includes a plurality of prism-shaped structures.

19. The backlight module as claimed in claim 1, wherein the light emitting surface includes a plurality of semicircle-shaped structures.

20. A liquid crystal display apparatus, comprising:
a liquid crystal display panel; and
a backlight module disposed below the liquid crystal display panel, wherein the backlight module comprises:
at least one light source; and
a light guide plate disposed at one side of the light source, wherein the light guide plate comprises:
a light emitting surface formed on the front side of the light guide plate;
a light reflection surface formed opposite to the light emitting surface;
at least one reducing region formed at one side of the light guide plate and close to the light source, wherein the thickness of the light guide plate in the reducing region is decreased with the increasing distance away from the light source; and
a light emitting region formed at one side of the reducing region and opposite to the light source to emit light.
